(19) United States
(12) Patent Application Publication
(10) Pub. No.: US 2005/0002772 A1
(43) Pub. Date: Jan. 6, 2005

(54) Mail container handling system

(76) Inventor: Robert L. Stone, Rockford, MI (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 10/722,160

(22) Filed: Nov. 25, 2003

Related U.S. Application Data
(60) Provisional application No. 60/484,682, filed on Jul. 3, 2003.

(51) Int. Cl. B65G 1/00

(52) U.S. Cl. 414/788; 414/331.06

(57) ABSTRACT

A mail container and cart handling system includes a container inspection system, a container handling or loading/unloading system and/or a cart management or handling system. The container inspection system may destack trays and determine whether the trays are damaged and may discharge acceptable containers for use. The container loading/unloading system may receive trays of articles and may move the trays onto shelves of a cart, or may receive carts of trays and may remove trays from the shelves of the carts. The cart handling system may arrange carts at a loading or unloading area and may buffer the carts at the area to provide the carts in an arranged manner for loading carts into a trailer or the like or for receiving and moving carts into a facility.

### CROSS REFERENCE TO RELATED APPLICATION

The present application claims priority of U.S. provisional application Ser. No. 60/484,682, Jul. 3, 2003, which is hereby incorporated herein by reference in its entirety.

### FIELD OF THE INVENTION

The present invention relates generally to article or mail sortation and delivery systems.

### BACKGROUND OF THE INVENTION

Trays for receiving sorted articles at an article sortation system, such as mail or the like, are typically reused after they have been emptied of their sorted articles. Stacks of such used trays are often shipped back to the mail or article sortation system for receiving a new batch of sorted articles. However, the trays are often damaged and sometimes no longer usable. The stacks of trays typically have to be manually unstacked and inspected at the sortation system.

After the containers or trays or tubs have gone through the sorting process, been filled or partially filled with sorted articles or mail, and been delivered to the run-out lines, they are typically placed into out-going carts by an operator. The operator or operators typically have to lift each tray and place the trays in the appropriate carts. This often requires a significant amount of manual labor which does not lend itself to an efficient process.

The carts of trays are often moved around the floor of the truck loading dock or facility until it is time to load them onto the appropriate truck or trailer. The carts thus may be positioned around the facility in an unorganized manner, such that it may be difficult to find the appropriate cart or carts. Also, the carts are typically manually moved around the facility and loaded into the trucks or trailers, which also does not lend itself to an efficient process.

Therefore, there is a need in the art for a container and cart handling system which overcomes the shortcomings of the prior art.

### SUMMARY OF THE INVENTION

The present invention provides a container inspection system for automatically destacking containers, inspecting and evaluating the condition of the containers, and restacking only the acceptable containers for use. The present invention also provides a container handling system that is operable to automatically load containers onto the appropriate shelves of a cart or unload containers from the shelves of carts. The present invention also provides a cart management system for automatically arranging carts at a truck loading facility or dock and loading the carts into the truck or trailer at the loading facility or dock.

According to an aspect of the present invention, a container or tray evaluating system includes a tray destacking device and a tray scanning device. The tray destacking device is operable to receive a stack of trays or containers and to destack the individual trays and to discharge the individual trays. The tray scanning device is operable to receive the individual trays from the tray destacking device and to scan the trays to determine the dimensions and orientation of the trays. The tray evaluating system is operable to determine if the scanned trays are in an acceptable condition for use.

The tray evaluating system may include a tray rotating device operable to rotate at least some of the trays to a desired orientation in response to the tray scanning device. The tray evaluating system may include a tray discharge operable to discharge trays that are not in an acceptable condition. The tray evaluating system may include a tray stacking device operable to stack acceptable trays to a desired height or number of trays. The tray evaluating system may also include a tray palletizer operable to arrange the stacks of acceptable trays on pallets for shipment of the trays.

According to another aspect of the present invention, a container handling system includes an induct for providing containers, a transfer unit and a container moving device. The container moving device is operable to move containers at least one of (a) from the transfer unit to an appropriate shelf of a cart adjacent to the transfer unit and (b) from an appropriate shelf of a cart adjacent to the transfer unit onto the transfer unit.

The transfer unit may be operable to arrange a plurality of containers on a loading portion of the transfer unit, and the container moving device may be operable to move the plurality of containers as a batch of trays to an appropriate shelf. Optionally, the transfer unit may be operable to singularly position a container at an appropriate location on the loading portion, and the container moving device may be operable to independently move each singularly positioned container to an appropriate shelf. Optionally, the shelves of the carts may be adjustable shelves, whereby when one shelf is filled with containers, the filled shelf may be moved from the loading portion and an empty shelf may be positioned at the loading portion.

According to another aspect of the present invention, a cart management system includes a first transport conveyor operable to transport carts therealong, a second transport conveyor operable to transport carts therealong, a plurality of buffers positioned between the first and second transport conveyors, and at least one discharge positioned along the second transport conveyor. The first transport conveyor is operable to selectively transfer carts onto the buffers, and the buffers are operable to selectively discharge carts onto the second transport conveyor.

The first transport conveyor may receive carts from an induct and the second transport conveyor may selectively discharge carts to at least one trailer loading device. Optionally, the first transport conveyor may receive carts from at least one trailer unloading device and the second transport conveyor may discharge carts to a discharge area. The first transport conveyor may be operable to move carts in opposite directions relative to the buffers to selectively arrange carts on the appropriate buffers and in an appropriate or desired order.

The buffers may be configured to receive stacks of carts, and the cart management system may be operable to stack carts at the buffers and to unstack carts from the buffers and to selectively discharge the unstacked carts to the second transport conveyor.

The first transport conveyor may include a transfer unit at each of the buffers. The transfer unit may be selectively operable to transfer carts from the first transport conveyor to the respective buffer. The transfer unit may be selectively operable to raise upwardly to lift the cart and to transfer the cart to the respective buffer. Optionally, the transfer units may be operable to convey carts along the transfer units in a direction generally along the first transport conveyor, and may selectively rotate, such as approximately 90 degrees, to change the direction of conveyance of the transfer unit to transfer the cart from the first transport conveyor to the respective buffer. The second transport conveyor may include a transfer unit at each of the buffers to transfer the carts from the respective buffer onto the second transport conveyor.

Therefore, the present invention provides an automatic tray inspection system which may automatically inspect and evaluate the condition of trays or containers and may orient and stack only acceptable trays for use. The present invention also provides an automatic tray handling system which receives trays or containers from an induct and automatically loads the trays onto shelves of carts for movement of the trays to their destination. The present invention also provides an automatic cart handling or management system which arranges carts at a truck or trailer loading dock or the like in an arranged manner and automatically conveys and discharges the carts to the appropriate truck or trailer or the like at the loading dock or facility. The present invention thus substantially reduces the manual labor that is typically required to inspect trays, to load trays of sorted articles into carts and to load the carts into trucks or trailers.

These and other objects, advantages, purposes and features of the present invention will become apparent upon review of the following specification in conjunction with the drawings.

### BRIEF DESCRIPTION OF THE DRAWINGS

FIG. 1 is plan view of a tray inspection system in accordance with the present invention;

FIG. 2 is a plan view of a container handling system in accordance with the present invention;

FIG. 3 is an upper perspective view of the container handling system of FIG. 2;

FIG. 4 is a side elevation of a tray moving device of the container handling system of FIGS. 2 and 3;

FIG. 5 is a perspective view of carts with adjustable shelves which are suitable for use with the container handling system of the present invention;

FIG. 6 is a perspective view of a modular or sectional cart suitable for use with the container handling system of the present invention;

FIG. 7 is a perspective view of a cart management system in accordance with the present invention;

FIG. 8 is a perspective view of a transport conveyor and transfer unit suitable for use with the cart management system of FIG. 7; and

FIG. 9 is a perspective view of another cart management system in accordance with the present invention, with storage buffers which hold stacked carts in a vertical cell.

### DESCRIPTION OF THE PREFERRED EMBODIMENTS

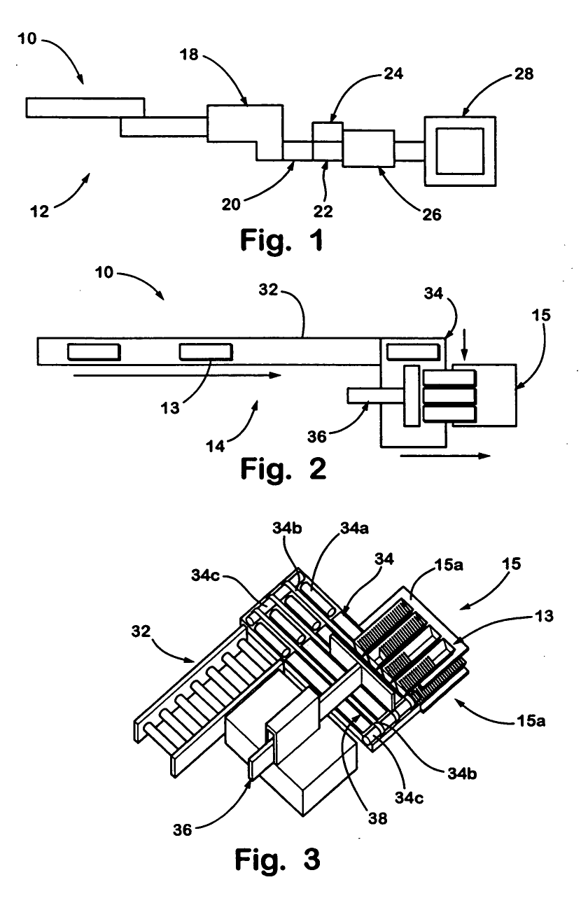

Referring now to the drawings and the illustrative embodiments depicted therein, a mail container and cart handling system 10 includes a container inspection system 12 (FIG. 1), a container handling or loading/unloading system 14 (FIGS. 2-4) and a cart management system or cart handling system 16 (FIGS. 7-9). Container inspection system 12 is operable to destack individual containers or trays 13 and to orient and inspect the containers to determine if the containers are damaged or otherwise unsuitable for use. The acceptable containers may then be stacked and may be palletized and moved to an appropriate area for use. Container loading/unloading system 14 is operable to receive trays or containers (such as trays that are filled or partially filled with sorted mail or other articles) from a feed conveyor and push or otherwise move groups of containers 13 onto the shelves 15a of a cart 15. Cart handling system 16 arranges the carts 15 at a discharge or loading area (such as where trucks or trailers or the like are loaded with the carts), such that the carts are readily moved or loaded into the appropriate truck or trailer or the like.

Container Inspection System

As shown in FIG. 1, container inspection system 12 includes a tray destacker 18 and a tray scanner, evaluator and rejecter 20. Tray destacker 18 is operable to unstack or destack individual trays from a stack of trays, and may comprise any destacking means. For example, tray destacker 18 may comprise a tray destacker of the type disclosed in U.S. pat. application Ser. No. 10/095,829, filed Mar. 12, 2002 by Schiesser et al. for TRAY DESTACKER (Attorney Docket RAP04 P-624B), which is hereby incorporated herein by reference. The tray destacker 18 receives stacks of trays, removes each tray individually from the stack and discharges the individual trays to the scanner, evaluator and rejecter 20. Scanner, evaluator and rejecter 20 scans each tray to determine its dimensions and to check for trays that are damaged beyond the desired or required specifications or limits. The scanner may also be operable to check for debris or articles left in the tray. The tray scanner may also determine the orientation of each tray or container. If the tray has a label or identification tag on it, the label may be removed, either automatically or manually.

The scanned trays or containers may then be moved to a tray rotator 22, where the tray may be rotated (such as in response to a signal from the scanner, evaluator and rejecter 20 which may indicate the orientation of the trays) such that all acceptable trays are in the same orientation. This may be beneficial so that the trays may readily have the identification labels positioned on the same side of each tray. If the tray is not within the desired specifications or limits, the tray may be discharged to a tray rejection area 24, either before or after tray rotator 22 has oriented the tray to the appropriate orientation. The acceptable and properly oriented trays may then be discharged to a tray stacker 26, which may then restack the trays (such as to a specified height or number of trays) for transportation of the trays to the area or facility at which the trays or containers will be used.

Optionally, after the trays have been stacked, the stacks of trays may be placed on a palletizer 28, which may be operable to properly place the stacks of trays onto a palette for shipment or movement to the appropriate area. The pallet, as loaded with the appropriate number of stacks of trays, may be wrapped and packaged for shipping, if desired.

The container inspection system of the present invention thus may automatically inspect trays received from a tray source (such as used trays from the Post Office or the like), and discharge stacks of acceptable trays. The container inspection system thus provides only acceptable trays to the area at which the trays are used without requiring manual inspection and discarding of the trays. The trays are then provided to the desired area, such as a tray handling system or tray management system at an article sortation system, which may be operable to sort articles and deposit articles into the trays. An example of such a tray handling system is disclosed in U.S. Pat. No. 6,561,339, which is hereby incorporated herein by reference. The container inspection system may be located at the facility where the trays are emptied (such as at a postal facility or the like) or at the sortation system facility or at any other suitable location or facility, without affecting the scope of the present invention.

Container Handling System

After the containers or trays or tubs have gone through the sorting process, and have been filled or partially filled with sorted articles or mail and delivered to the run-out lines, the trays may be automatically loaded into out going carts via container handling system 14. Container handling system 14 is operable to load the trays into the multi-shelved carts one level of trays at a time, either in a batch form or a singulated form, depending on the particular application. After each load of trays, the container handling system may automatically set itself to receive the next load of trays.

As shown in FIGS. 2 and 3, the trays 13 filled or partially filled with sorted articles, such as mail or flats mail or the like, are received at container handling system 14 via a feed or delivery conveyor 32. Container handling system 14 includes a transfer unit 34 and a pusher/retriever or tray moving device 36. The filled or partially filled trays may travel down the run-out lanes of the facility or down or along the delivery conveyor 32 and towards the container handling system 14. The delivery conveyor may comprise a motorized roller conveyor, or any other type of conveyor or conveying or moving means, without affecting the scope of the present invention.

The transfer unit 34 may be positioned generally at the downstream end of the delivery conveyor 32 to receive trays 13 from the delivery conveyor 32. As shown in FIG. 3, transfer unit 34 may include a plurality of rollers 34a positioned at the downstream or discharge end of the delivery conveyor 32 for receiving and supporting trays received from delivery conveyor 32. The transfer unit 34 may also include a plurality of belts 34b wrapped or reeved around opposite end rollers 34c of the transfer unit and extending generally between at least some of the rollers 34a. The rollers 34c and belts 34b are operable or drivable to move the trays received from the delivery conveyor 32 onto a loading platform 38 of transfer unit 34. For example, the rollers 34c may be raised upward relative to rollers 34a to position the upper run of the belts 34b above the conveying surface of the rollers 34a, and then may be driven to move or convey the trays to the loading platform 38. The trays thus may be transferred onto the loading platform where the proper quantity of trays may be arranged for filling a shelf of a cart (such as three or four in a row side by side). A cart 15 may be positioned adjacent to the loading platform 38 to receive the trays from the platform 38. The cart may have adjustable or movable shelves 15a, such as self adjusting shelves or the like.

As can be seen in FIG. 5, each cart 15 may include a plurality of shelves 15a which may be configured to receive a row of trays and to move the trays away to accept the next row of trays on an empty shelf. In the illustrated embodiment of FIG. 5, the cart 15 includes self adjusting shelving in order to accomplish this feature. The shelves 15a may actuate or move via springs and gravity or via an electrical motor and sensors or the like. As the trays are loaded onto the shelves, the springs may be engaged which will drop the shelf down one level, moving the next shelf into position to receive more trays. Optionally, an electrical version may include a sensor that may detect and acknowledge when the shelf is full, whereby the cart may move the shelves down one level to align an empty shelf with the loading platform to receive the next batch of incoming trays. Optionally, the cart may have a self adjusting base shelf and each level of trays may be stacked onto the level of trays directly below. In such an embodiment, the top tray or level of trays may rest on the articles in the next lower tray or level of trays, on the sleeve of the next lower tray or level of trays, on the lid of the next lower tray or level of trays, or on a separate slip sheet that may be placed between layers of trays by the loading device (or removed by the unloading device). The self adjusting or automatically adjusting shelved cart provides an ergonomic benefit and simpler loading device for loading trays or containers into carts. The carts may be provided in multiple sizes, such as a large container size and smaller sizes, which may be selected by dropping by halves of the larger sizes down to the smallest, in order to provide three or four cart variations. This feature, combined with the stack-ability of the carts, is intended to increase the trailer loading efficiency. By having the correct arrangement of cart sizes, and by using the ability to stack carts, trailers can be loaded substantially completely with carted contents.

On the loading platform 38, the trays may be tight together and may have the short side of the trays facing the cart or rolling stock. Optionally, for a batch process, the trays may be moved onto the loading platform 38 until their leading side contacts the other adjacent tray on the platform. After the desired number of trays are positioned on the loading platform, all of the trays on the platform may be moved onto the appropriate shelf of the adjacent cart. The pusher or tray moving device 36 may be activated to push or slide the trays off of the platform 38 and onto the adjacent shelf of the cart. After the moving device 36 moves the trays onto the appropriate shelf, the moving device 36 retracts to receive a new set or batch of trays onto the loading platform 38, while the cart shelves may adjust or move to position a new empty shelf or level at the platform (or a new cart may be provided at the platform). When the pusher has retracted, a new row of trays may transfer over onto the loading platform and the process may repeat.

Optionally, for a singulated process of loading trays onto carts, there may be multiple (such as three or four) separate stopping locations on the loading platform for the trays to stop as they are moved onto the loading platform via belts 34b. For example, the first tray may be moved to the end of the platform and then may be pushed onto the shelf of the cart. After the pusher is retracted, the second tray may be moved onto the platform and may be stopped at a desired location by a pop-up stop or the like, and then may be pushed onto the shelf of the cart next to the first tray. The process may be repeated for the third and fourth trays (or whatever number of trays is appropriate or desired), with stops positioned along the platform at the appropriate or desired locations.

Once all of the trays are on the cart shelf, the cart shelf height may self adjust down, and a new empty shelf or level may move down to receive the next set or batch of trays. With self adjusting shelved carts, the loader may load carts without any adjustment. Optionally, if self adjusting shelves are not used, such adjustment could be performed within the system. For example, a sensor, such as either of a proximity or photoelectric mode or type, may be used to determine if the shelves are in the correct position. The cart loading station of the container handling system may then have a vertical adjustment device, such as a pneumatic lift unit or the like, which may raise the shelf assembly to the proper height for loading. When all shelves are loaded, the shelves are lowered and released and the cart is removed from the system.

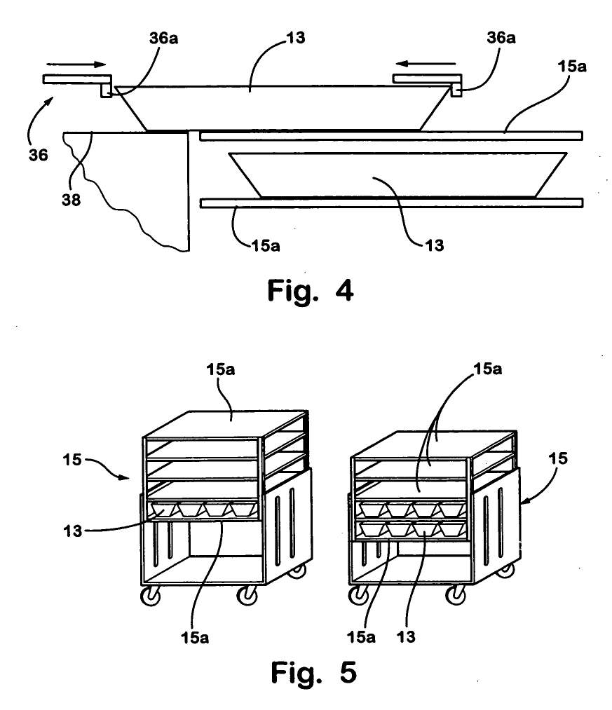

Although shown and described for loading the shelves of a cart with trays or containers, the container handling system of the present invention is equally suitable for unloading the shelves of the carts. For unloading the carts, the reverse of the operation described above may be performed. As can be seen in FIG. 4, the tray moving device 36 may have a lip or hook or downward depending portion 36a. The portion 36a may push against an end of the tray or trays to push the trays onto the shelves of the carts, while the portion may also or otherwise engage or hook the opposite end of the trays to pull the trays from the shelves. For example, the pusher/retriever arm may extend into the cart over the trays, and may lower down to engage or latch onto the trailing or opposite edge or end of the trays, and pull the trays to the loading shelf in a batch or single tray form. The trays may then be transferred to a discharge conveyor or other discharge station or the like and may be taken away by the conveyor system or the like.

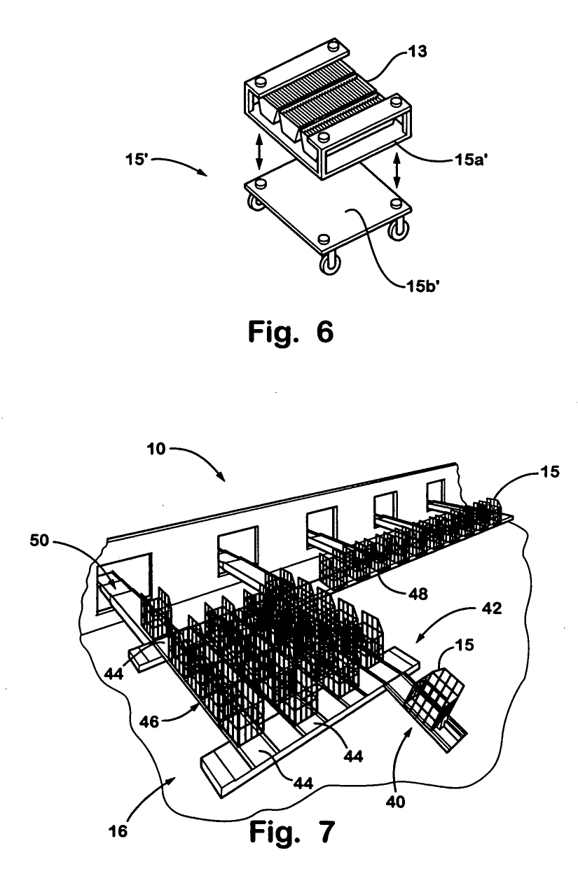

Optionally, and as shown in FIG. 6, another rolling stock or cart 15′ may comprise a modular or sectional cart which may be broken down to save space when it is not in use. The shelves 15a′ may be stacked and used (and may be stacked onto a base 15b′ with casters or the like), but they may be their own separate entities. Each shelving block may be loaded separately with multiple mail trays (such as three trays as shown in FIG. 6) and may then be stacked on the wheeled base 15b′ until the desired cart height is achieved. The shelves may employ a latch mechanism or locking device that keeps the shelves locked together as a single unit. These latch mechanisms may be released by a cart stacking and unstacking device. The sectional cart design may enhance the capability of the carts to ensure that the physical envelope of the final cart is fully loaded with mail, thereby minimizing wasted air volume during shipping. Handling the units or shelves or sections may be done by any means available, such as a conveyor, power and free system, or any other set up that the facility might be equipped with. Such a cart handling system and sectional cart may allow transportation of the full shelves or sections or carts above the floor and thereby decrease the necessary floor space required. The units may be conveyed to either a dispatch area, where the carts may be “built up” for shipping, or to a sorting area, where the carts or sections may be broken down for unloading, staged and processed. When the filled shelves are delivered to the stacking area, the cart stacking system may be used to position the shelves on top of the formed stack. Such a cart stacking system may stack and assemble a complete cart, and may extract the assembled cart for movement. Conversely, when a full cart reaches the unstacking station, an unstacking system may be employed to unlatch the shelves and remove the shelves or sections. Such a system may be either fully or partially automated, or lift assist.

The container handling system of the present invention thus may achieve labor savings in handling containers and carts. The container handling system allows the facility to be able to load and unload carts automatically, eliminating the cost of a mail handler or operator manually stacking tubs or trays onto rolling stock. Not only will the loader save on labor, but compared to a fully robotic system, the loader may save a great deal of money on automation.

Also, the container handling system may increase distribution efficiency. The automatic loader and shelved ergo cart may allow carts to be loaded quickly and accurately. Using the loader of the present invention may ensure that the carts are loaded to their full capacity. This may allow the workers to concentrate their efforts on getting the carts onto the trucks, which in turn will help get more trucks filled in a given period of time.

The container handling system of the present invention may also save labor through automation by providing a significant reduction in the amount of manual labor required to load and unload the carts. The workers may still put the carts in position and take them away, but this can be done by fewer workers than what it takes to load carts with trays. The present invention thus also may reduce the occurrence of repetitive motion injuries. Because the automatic loader may fill up the rolling stock or cart instead of the operators having to do this, an extreme amount of bending and twisting by the operators is reduced. For example, the loader of the present invention may avoid the operator having to bend to reach into the bottom of carts to retrieve trays and to twist while moving trays off the supply conveyor and into carts.

Also, the container handling system of the present invention may reduce the frequency with which individual containers are handled, which may reduce occurrences of product damage. The trays or tubs may be pushed into a shelved cart by the pusher device. Also, the trays or containers may no longer sit on top of each other and will not be thrown into the carts by workers.

The container handling system of the present invention may also maintain production efficiency with a steady flow of product. The flow of the product through the system will be shifted from the speed or amount of time it takes for a person to load a cart to the speed or amount of time it takes to switch out full carts. This is a much quicker and simpler task that could greatly increase the number of carts that can be handled at the loading docks.

Cart Management System

As shown in FIGS. 7-9, cart management system 16 includes a loading/unloading station or location or area 40, a transportation or tracking conveyor 42, transfer units 44, multiple storage buffers 46, a second transportation conveyor 48 and one or more extendible loaders/unloaders 50 that will send or load the carts into the trucks or trailers or retrieve or unload the carts from the trucks or trailers. To accommodate different facilities and mail streams, the cart management system may be designed to handle carts, pallets, and/or other necessary mail or article containers. The workers may only interact at the loading point or area, where carts are either added or delivered to the cart management system, and in the trucks or trailers, where the carts are loaded and unloaded. Once the carts are received into the cart management system, they may be placed into high density storage, which may be all at floor level, or may be a multiple level fashion, as discussed below. The storage area will save on floor space and allow for quick and efficient loading of the trucks or trailers when the trucks arrive at the loading dock. In the truck or trailer, an extendible loader/unloader may assist the worker in the organization of loaded carts and the unloading of carts while less time is wasted in worker movement.

In an attempt to optimize the system's capabilities, the carts may be designed to provide added benefits, such as use of the entire space available in a truck or trailer or the like. The carts may vary in size, but preferably will be able to fit together to maximize storage within a given space. Optionally, the carts may be designed to fit different applications. For example, there may be a large cart that may not move or maneuver well on the floor, but may be beneficial for travel, while smaller carts may be provided for use on the floor to allow for ease in pushing and pulling, but may be stacked to generally equal a larger cart. The system may use these or other variations to fill the trucks in a more efficient pattern.

Optionally, as the carts are loaded into, or taken from the system by a worker, they may be stacked by a stacking unit. Depending on if stackable units are available in the facility, the stacking unit or stacker may stack two or more carts or units together before they are loaded onto a truck. The same may be done in the opposite direction for carts coming off of trucks. The stacking unit may then take the stacked carts and de-stack them before the workers take them into the building. By placing a container stacking/destacking unit in such a location, the stacked carts may be handled by an automated system, thereby reducing or substantially eliminating the need for an operator to move tall, possibly difficult to maneuver and/or unstable, carts.

The tracking or transport conveyor 42 may be operable to move the carts from the stacker or loading station 40 to the storage buffers 46, while the transport conveyor 48 may be operable to move the carts from the storage buffers to the appropriate extendible loader/unloader or conveyor 50. After the carts are loaded or input into the system at loading area 40, the transport conveyor 42 may be operable to move the carts to the transfer units 44 where they may be selectively released or transferred to their destination. The transport conveyor and transfer units may be cooperatively operable to move the carts along the transport conveyor, and may move the carts in either direction along the transport conveyor. For example, if a first cart and a second cart are loaded at the induct but it is desired that the second cart be positioned on the buffer ahead of the first cart, the transport conveyor may convey the first cart past the appropriate buffer and divert the second cart onto the appropriate buffer, and then reverse direction to move the first cart back to the appropriate buffer, where it may be diverted onto the appropriate buffer behind the second cart. The transport conveyor and transfer units thus may selectively move the carts relative to the buffers and may selectively transfer the carts to the desired buffer in a desired order in order to arrange the carts on the buffers in a desired manner.

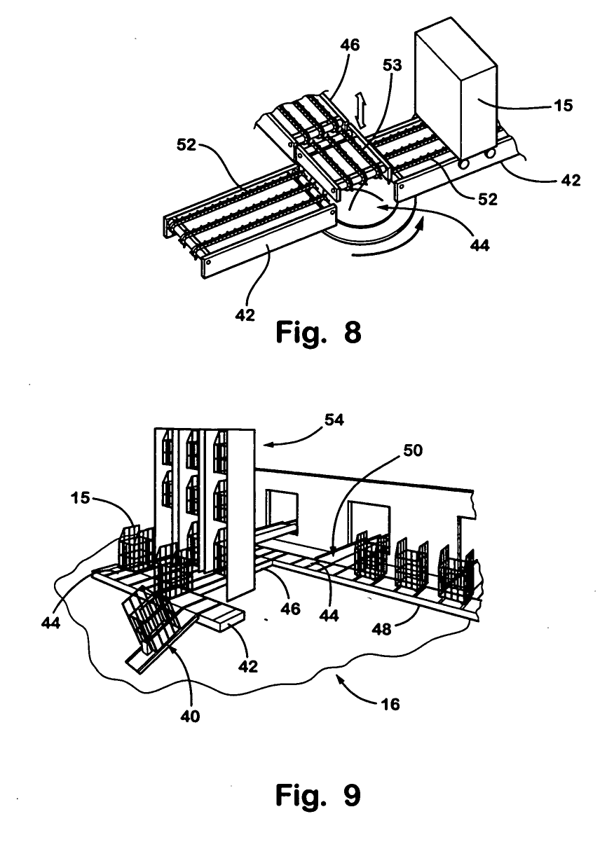

In the illustrated embodiment, and as best shown in FIG. 8, conveyors 42, 48 include a plurality of chains 52 (such as three or four lines of chain) that the bottom of the cart or pallet being transported may contact or rest on. The chain lines may move the carts and keep the casters of the carts off of the ground or conveyor, thereby minimizing or substantially eliminating problems or concerns with caster misalignment, and thus maintaining positive control over the position of the cart. The chains may have a common drive, which may be sufficient in size to handle the load of multiple carts.

Both of the transportation conveyors 42, 48 include a plurality of transfer units 44 positioned therealong. In order to load the carts onto or to divert the carts from the transportation conveyor, the transfer units are positioned at each area where the carts will be diverted, such as at each storage buffer or at an extendible loader/unloader. For example, the transportation conveyor 42 may include transfer units 44 positioned generally at the ends of the buffers 46, while transportation conveyor 42 may include transfer units 44 positioned at the ends of the buffers 46 and at the ends of the extendible loaders/unloaders 50. The conveyor 42, 48 may be operable to move the carts to the appropriate divert point or transfer unit 44 and the transfer unit 44 may rise up to accept the cart. When the transfer unit 44 is at approximately the same height as the storage buffer or extendible conveyor, the transfer unit may be selectively activated to transfer or divert the cart onto the storage buffer or extendible conveyor. The lift device may be a pneumatic lift to add control, handle weight, and minimize cost of the system. Optionally, and as shown in FIG. 8, the transferring of the carts by the transfer unit may be accomplished by a rotating transfer unit 44 to divert or change the direction of conveyance of the carts. The transfer unit 44 may include a chain conveyor 53 similar to the transportation conveyors 42, 48, and may rotate (such as approximately 90 degrees as shown in FIG. 8) when a cart is positioned thereon to change the direction of the chain drive such that when the chain drive 53 of the transfer unit is activated, the carts are moved from the transfer unit onto the adjacent buffer or transportation conveyor or extendible loader/unloader or the like.

The cart management system of the present invention thus provides buffer storage of carts to limit or substantially eliminate carts waiting for a truck from being spread all over the dock floor. The storage lines or buffers may use the same conveying means as the transportation lines, as can be seen in FIG. 8. Depending on the room that a facility has available, a single level storage may be implemented. The length and number of rows of storage may be determined based on the flow of carts into the building. After this is determined, multiple rows may be laid out on the loading dock floor. This layout may consist of a chain conveyor design with tabs that engage the cart, as described above. By using an identification code label on each cart, the system may dispatch the proper cart to the appropriate trailer being filled.

Optionally, if floor space is lacking at the facility, storage towers 54 (FIG. 9) may be added to keep the footprint of the storage system to a minimum. To achieve the multiple level storage, the carts may be lifted, such as from the bottom or other area of the carts, into storage towers. For example, as the carts travel on the transportation conveyor, they may pass over a lifting unit, which may function to lift or raise the cart to the appropriate level and to discharge the cart onto a raised platform or shelf or onto the top of another cart. This process may be repeated until the towers are full. When the stored carts are needed they may be moved out of the towers in the opposite order of how they arrived (however, if the storage tower has fixed shelves or platforms, the carts may be removed in any order).

Present conventional processes of loading and unloading a truck require a high amount of manual labor and time to take the carts from the loading docks and push them all the way to the end of the trailer. For the cart management system of the present invention, an extendible conveyor or loader/unloader may be used to reduce the time and movement that the worker would normally require. The cart management system may reduce the labor required, and may also decrease the amount of time it takes to load a trailer, thereby increasing the sortation operating window of the facility. The extendible conveyor or loader/unloader is substantially similar to loader/unloaders commercially available from various sources, and/or may be similar to the types disclosed in U.S. Pat. Nos. 5,351,809; 5,423,413; 6,006,893; and 6,481,563, which are hereby incorporated herein by reference. However, the extendible conveyor or loader/unloader of the cart management system of the present invention may be designed to handle the increased weight of the carts, as opposed to cartons, and may have the ability to control the movement of the carts while they are being conveyed, without affecting the scope of the present invention.

The extendible loader/unloader may extend into the truck or trailer to meet up to the worker in the truck to either deliver carts for loading into the truck or trailer, or to assist in emptying or unloading carts from the trailer. As the extendible loader/unloader extends, the weight of the carts may be supported underneath while mechanisms on the side or bottom of the loader/unloader may push the carts along the conveyor. During loading of a trailer, the cart may travel down the sections of the extendible loader/unloader until it reaches the end, where it may encounter a lowering device. The lowering device or end unit elevator may transfer the cart or pallet off the extendible conveyor, and may support it from the sides, and lower the cart to the floor where it is released to the worker. The lowering device may consist of an electric motor and a sensing device. The sensing device may detect the height of the end of the extendible conveyor, which may be necessary because the precise height of the conveyor surface may change depending on the characteristics of the extendible unit and its relationship to the trailer.

The cart management system of the present invention thus may obtain efficient space utilization with high density storage buffers, which allows carts to be stored in a very compact way without the workers having to search through the group to find certain carts. The present invention thus may reduce or substantially eliminate carts being spread all over the loading dock floor, while positioning the carts in a predictable location for ease in distribution. The present invention may also achieve optimal levels of production through the creation of such open storage capacity. As carts or rolling stock are added to the system, other carts may be removed to be taken away by the trucks. There is thus a flow of product that may be observed and studied for further improvement.

Also, the cart management system of the present invention may improve order picking efficiency with a continual supply of carts. More particularly, when carts are moved onto the loading dock, the present invention provides an in-feed point or location where the carts can be taken and handled only once. Workers are freed up from searching and loading carts and may concentrate on a better flow of product. Also, as the trucks are prepared, there is a steady supply of carts being prepared, so that once the truck is ready there may be a generally constant stream of carts into the truck, thus limiting the amount of time that the truck has to be docked.

Changes and modifications in the specifically described embodiments may be carried out without departing from the principles of the present invention, which is intended to be limited only by the scope of the appended claims as interpreted according to the principles of patent law.

1. A tray evaluating system comprising:
a tray destacking device operable to receive a stack of trays and to destack individual trays from the stack and to discharge the individual trays; and
a tray scanning device operable to receive the individual trays from said tray destacking device and to scan the trays to determine the dimensions and orientation of the trays, said tray evaluating system being operable to determine if the scanned trays are in an acceptable condition for use.

2. The tray evaluating system of claim 1, wherein said tray scanning device is operable to determine if articles or debris are within the individual trays.

3. The tray evaluating system of claim 1 including a tray rotating device operable to rotate at least some of the trays to a desired orientation in response to said tray scanning device.

4. The tray evaluating system of claim 1 including a tray discharge operable to discharge trays that are not in an acceptable condition.

5. The tray evaluating system of claim 1 including a tray stacking device operable to stack acceptable trays to a desired height or number of trays.

6. The tray evaluating system of claim 5 including a tray palletizer operable to arrange stacks of acceptable trays on pallets for shipment of the trays.

7. A container handling system for loading/unloading trays on a cart, said container handling system comprising:
a transfer unit positioned at a conveyor; and
a container moving device operable to move containers at least one of (a) from said transfer unit to an appropriate shelf of a cart adjacent to said transfer unit, and (b) from an appropriate shelf of a cart adjacent to said transfer unit onto said transfer unit, said transfer unit being operable to at least one of (a) receive containers from the conveyor and transfer the containers to said container moving device and (b) receive containers from said container moving device and transfer the containers to the conveyor.

8. The container handling system of claim 7, wherein said container moving device is operable to move containers from said transfer unit to an appropriate shelf of a cart adjacent to said transfer unit.

9. The container handling system of claim 8, wherein said transfer unit receives containers at an induct and transfers the containers to a loading portion of said transfer unit, said container moving device moving containers from said loading portion to the appropriate shelf.

10. The container handling system of claim 9, wherein said transfer unit is operable to singularly position a container at an appropriate location on said loading portion, said container moving device being operable to move each singularly positioned container to the appropriate shelf.

11. The container handling system of claim 9, wherein said transfer unit is operable to position multiple containers on said loading portion, said tray moving device being operable to move multiple containers as a batch from said loading portion to the appropriate shelf.

12. The container handling system of claim 7, wherein said container moving device is operable to move containers from an appropriate shelf of a cart adjacent to said transfer unit onto a loading portion of said transfer unit.

13. The container handling system of claim 12, wherein said transfer unit is operable to move containers from said loading portion to a discharge of said transfer unit.

14. The container handling system of claim 7, wherein the shelves of the cart are adjustable shelves, whereby when one shelf is filled with containers, the filled shelf is moved from said container moving device and an empty shelf is positioned at said container moving device.

15. A cart management system for managing carts of trays at a loading/unloading area of a material handling facility, said cart management system comprising:
a first transport conveyor operable to receive carts at an induct and to transport carts of trays along said first transport conveyor;
a second transport conveyor operable to transport carts therealong;
a plurality of buffers positioned between said first and second transport conveyors, said first transport conveyor operable to selectively transfer carts onto said buffers, said buffers being operable to selectively discharge carts onto said second transport conveyor; and
at least one discharge positioned along said second transport conveyor.

16. The cart management system of claim 15, wherein said first and second transport conveyors comprise at least one drive member operable to move carts therealong.

17. The cart management system of claim 15, wherein said first transport conveyor receives carts from an induct station and said second transport conveyor selectively discharges carts to at least one trailer loading device.

18. The cart management system of claim 15, wherein said first transport conveyor receives carts from at least one trailer unloading device and said second transport conveyor discharges carts to a discharge area.

19. The cart management system of claim 15, wherein said first transport conveyor is operable to move carts in opposite directions relative to said buffers to selectively arrange carts on the appropriate buffers and in the appropriate order.

20. The cart management system of claim 15, wherein said buffers are configured to receive stacks of carts, said cart management system being operable to stack carts at said buffers.

21. The cart management system of claim 20, wherein said cart management system is operable to unstack carts from said buffers and to selectively discharge the unstacked carts to said second transport conveyor.

22. The cart management system of claim 20, wherein said second transport conveyor is operable to transport the stacked carts to said at least one discharge to discharge the stacked carts.

23. The cart management system of claim 15, wherein said first transport conveyor includes a transfer unit at each of said buffers, said transfer unit being selectively operable to transfer carts from said first transport conveyor to the respective buffer.

24. The cart management system of claim 23, wherein said transfer unit is selectively operable to raise upwardly to lift the cart and to transfer the cart to the respective buffer.

25. The cart management system of claim 23, wherein said transfer units are operable to convey carts along said transfer units in a direction generally along said first transport conveyor.

26. The cart management system of claim 25, wherein each of said transfer units is selectively operable to rotate to change the direction of conveyance of said transfer unit to selectively transfer the cart from said first transport conveyor to the respective buffer.
